(19) United States
(12) Patent Application Publication
(10) Pub. No.: US 2026/0131481 A1
(43) Pub. Date: May 14, 2026

(54) FINGER, ROBOT HAND, AND ROBOT

(71) Applicant: Zhejiang Qiangnao Technology Co., Ltd., Hangzhou (CN)

(72) Inventors: Bicheng HAN, Hangzhou (CN); Wenguang WANG, Hangzhou (CN); Disi A, Hangzhou (CN); Yiqian GAO, Hangzhou (CN); Zhan LU, Hangzhou (CN); Junhan LI, Hangzhou (CN)

(73) Assignee: Zhejiang Qiangnao Technology Co., Ltd., Hangzhou (CN)

(21) Appl. No.: 19/361,248

(22) Filed: Oct. 17, 2025

(30) Foreign Application Priority Data
Nov. 14, 2024 (CN) 202411622372.8

(51) Int. Cl. B25J 15/00

(52) U.S. Cl. CPC B25J 15/0009

(57) ABSTRACT

A finger, a robot hand, and a robot are provided. The finger includes an installation frame, a finger sleeve rotatably arranged at the installation frame, a finger portion rotatably arranged at the installation frame, located inside the finger sleeve, and capable of sliding inside the finger sleeve, and a driving assembly. The driving assembly is configured to drive the finger portion to slide relative to the finger sleeve, so that the finger sleeve and the finger portion rotate relative to the installation frame. The driving assembly can be installed at the finger portion or the finger sleeve, and does not need to be installed at the installation frame, so that the overall structure of the finger is more concentrated and does not occupy the space of other structures.

### CROSS-REFERENCE TO RELATED APPLICATIONS

The present application claims priority to Chinese Patent Application No. 202411622372.8, filed on Nov. 14, 2024, the content of all of which is incorporated herein by reference.

### TECHNICAL FIELD

The present disclosure relates to the technical field of robots, in particularly to a finger, a robot hand, and a robot.

### BACKGROUND

A robot hand is generally designed to mimic a human hand. A finger of the robot hand has multiple knuckles, and the knuckles are rotatably connected in sequence to achieve the flexion and extension of the finger.

In the prior art, the finger of the robot hand mainly realizes the rotation of the knuckles through a driving structure. The driving structure is generally arranged at a palm of the robot hand. The driving structure of the finger occupies space in the palm, resulting in nonuniform structural distribution.

Therefore, the prior art still needs to be improved and developed.

### SUMMARY

In view of the above-mentioned defects of the prior art, the present disclosure provides a finger, a robot hand, and a robot to solve the problem that the driving structure of the finger in the prior art occupies space in the palm, resulting in nonuniform structural distribution.

Technical solutions of the present disclosure to solve technical problems are as follows.

A finger, includes:
an installation frame;
a finger sleeve, rotatably arranged at the installation frame;
a finger portion, rotatably arranged at the installation frame, located inside the finger sleeve, and capable of sliding inside the finger sleeve; and
a driving assembly, configured to drive the finger portion to slide relative to the finger sleeve, so that the finger sleeve and the finger portion rotate relative to the installation frame.

In some embodiments, the finger further includes:
a base, rotatably connected to the installation frame; and
a first driving member, arranged at the base;
where the first driving member is configured to drive the installation frame to rotate.

In some embodiments, a rotation direction of the base relative to the installation frame is perpendicular to a rotation direction of the finger sleeve relative to the installation frame.

In some embodiments, a resistance adjustment structure is arranged at the base, and the resistance adjustment structure is configured to adjust resistance of the installation frame to rotate relative to the base.

In some embodiments, the first driving member is a folding motor.

In some embodiments, the driving assembly includes:
a second driving member, arranged at the finger portion; and
a connector, connected to the finger sleeve;
where the second driving member drives the connector to move relative to the finger portion.

In some embodiments, an output shaft of the second driving member is arranged with a threaded rod; and
the connector is arranged with a screw hole, and the screw hole is threadedly connected to the threaded rod.

In some embodiments, the finger further includes:
an extended finger, rotatably connected to the finger sleeve and the finger portion respectively.

A method for controlling the finger as described in any one of the above, includes:
controlling the driving assembly to drive the finger portion to slide relative to the finger sleeve, so that the finger sleeve and the finger portion rotate relative to the installation frame.

In some embodiments, the method further includes:
controlling the first driving member to drive the installation frame to rotate relative to the base.

A robot hand, includes the finger as described in any one of the above.

A robot, includes the finger as described in any one of the above, or the robot hand as described above.

Beneficial effects: The driving assembly drives the finger portion to slide relative to the finger sleeve to achieve that the finger sleeve and the finger portion both rotate relative to the installation frame, thereby realizing the rotation of the knuckle formed by the finger sleeve and the finger portion. The driving assembly can be installed at the finger portion or the finger sleeve, and does not need to be installed at the installation frame, so that the overall structure of the finger is more compact and does not occupy the space of other structures.

### BRIEF DESCRIPTION OF DRAWINGS

FIG. 1 is a schematic diagram of a structure of a finger in the embodiments of the present disclosure.

FIG. 2 is a schematic diagram of a structure of the finger after removing a finger sleeve in the embodiments of the present disclosure.

FIG. 3 is a cross-sectional view of the finger in the embodiments of the present disclosure.

FIG. 4 is a schematic diagram of a structure of a finger portion in the embodiments of the present disclosure.

FIG. 5 is a schematic diagram of a structure of the finger sleeve in the embodiments of the present disclosure.

FIG. 6 is a schematic diagram of a structure of the finger after removing an extended finger in the embodiments of the present disclosure.

FIG. 7 is a schematic diagram of a structure of a resistance adjustment structure in the embodiments of the present disclosure.

FIG. 8 is a flow chart of a method for controlling the finger in the embodiments of the present disclosure.

### DETAILED DESCRIPTION OF EMBODIMENTS

In order to make the purposes, technical solutions, and advantages of the present disclosure clearer and more specific, the present disclosure is further described in detail below with reference to the accompanying drawings and embodiments. It should be understood that the embodiments described herein are only used to explain the present disclosure and are not used to limit the present disclosure.

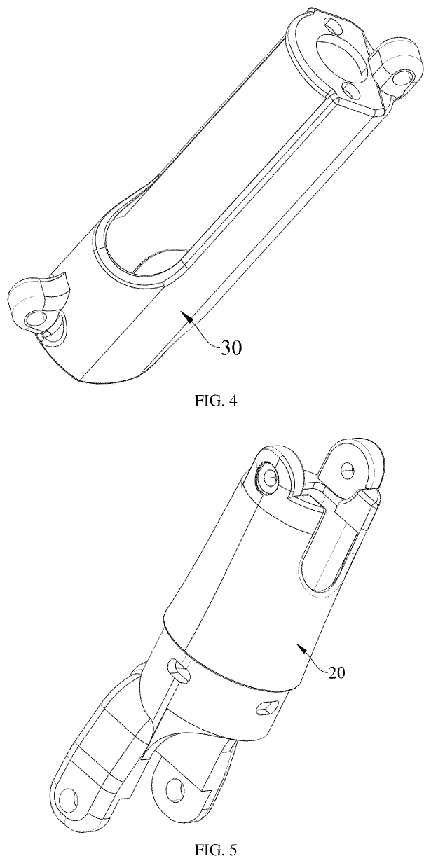

Referring to FIGS. 1 to 7 simultaneously, the present disclosure provides some embodiments of a finger.

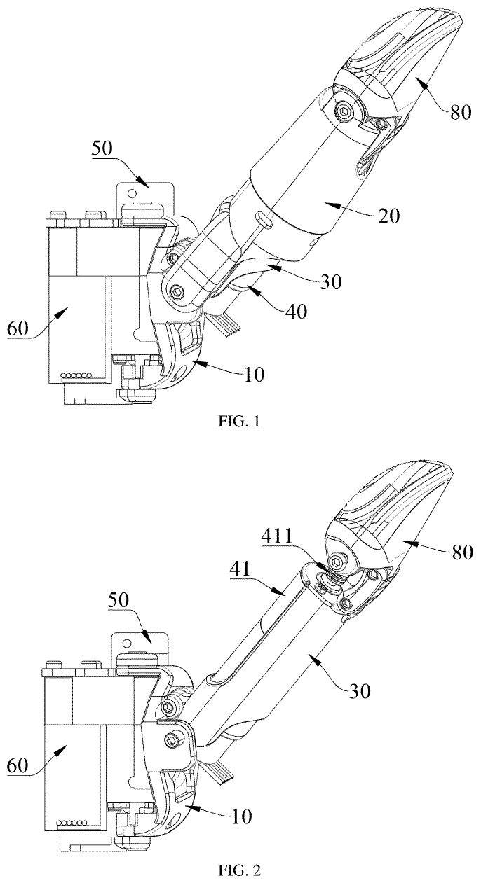

As shown in FIG. 1 and FIG. 2, the finger of the present disclosure includes:
an installation frame 10;
a finger sleeve 20, rotatably arranged at the installation frame 10;
a finger portion 30, rotatably arranged at the installation frame 10, located inside the finger sleeve 20, and capable of sliding inside the finger sleeve 20; and
a driving assembly 40, configured to drive the finger portion 30 to slide relative to the finger sleeve 20, so that the finger sleeve 20 and the finger portion 30 both rotate relative to the installation frame 10.

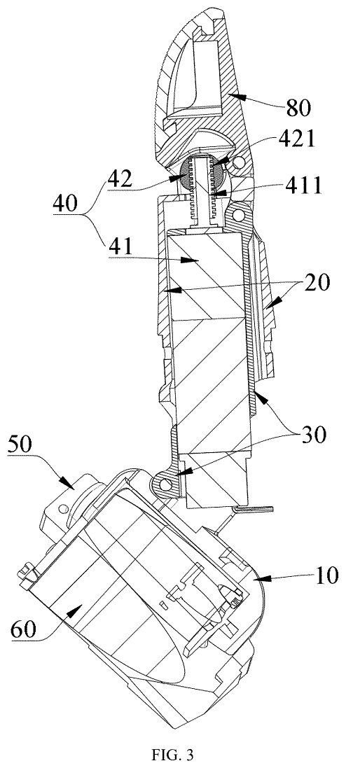

The installation frame 10 is used to install the finger at an additional structure, for example, the installation frame 10 is arranged at abase 50. The finger sleeve 20 and the finger portion 30 form one knuckle, and the finger sleeve 20 and the finger portion 30 are both rotatably connected to the installation frame 10. The finger portion 30 is located inside the finger sleeve 20 and is capable of sliding inside the finger sleeve 20 (as shown in FIGS. 3, 4, and 5). When the finger sleeve 20 and the finger portion 30 rotate relative to the installation frame 10, the finger portion 30 slides relative to the finger sleeve 20. Conversely, when the finger portion 30 slides relative to the finger sleeve 20, the finger sleeve 20 and the finger portion 30 rotate relative to the installation frame 10. The driving assembly 40 drives the finger portion 30 to slide relative to the finger sleeve 20 to realize the rotation of the finger sleeve 20 relative to the installation frame 10 and the rotation of the finger portion 30 relative to the installation frame 10, thereby realizing the rotation of the knuckle formed by the finger sleeve 20 and the finger portion 30. The driving assembly 40 may be arranged at the finger portion 30 or the finger sleeve 20, and does not need to be arranged at the installation frame 10, so that the overall structure of the finger is more concentrated and does not occupy the space of other structures.

The driving assembly 40 is configured to drive the finger portion 30 to slide relative to the finger sleeve 20, but does not directly drive the finger sleeve 20 or the finger portion 30 to rotate relative to the installation frame 10. The driving assembly 40 drives the finger portion 30 to slide relative to the finger sleeve 20, thereby indirectly driving both the finger sleeve 20 and the finger portion 30 to rotate relative to the installation frame 10, which is conducive to using driving assemblies 40 of different structures to realize the rotation of the finger, and leads to a more diversified structural layout.

In an implementation of the embodiments of the present disclosure, as shown in FIGS. 1 to 3, the finger further includes:
the base 50, rotatably connected to the installation frame 10; and
a first driving member 60, arranged at the base 50;

The first driving member 60 is configured to drive the installation frame 10 to rotate.

The installation frame 10 is arranged at the base 50, and the installation frame 10 is capable of rotating relative to the base 50. The first driving member 60 is arranged at the base 50 and connected to the installation frame 10, and is configured to drive the installation frame 10 to rotate relative to the base 50. The driving assembly 40 can be arranged at the knuckle, and the first driving member 60 is arranged at the base 50. The driving assembly 40 and the first driving member 60 are arranged at different positions to separate the driving structure, which is further conducive to the structural layout.

In an implementation of the embodiments of the present disclosure, as shown in FIG. 1 and FIG. 2, a rotation direction of the base 50 relative to the installation frame 10 is perpendicular to a rotation direction of the finger sleeve 20 relative to the installation frame 10.

The rotation direction of the installation frame 10 relative to the base 50 is a first direction, and the rotation direction of the finger sleeve 20 or the finger portion 30 relative to the installation frame 10 is a second direction. The first direction and the second direction are different directions, for example, the first direction is perpendicular to the second direction.

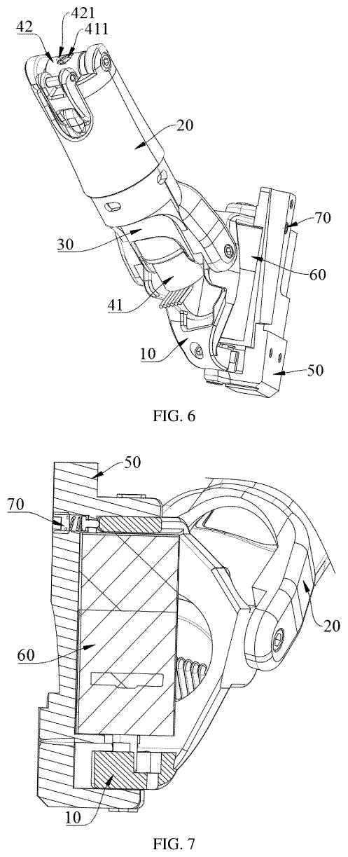

In an implementation of the embodiments of the present disclosure, as shown in FIG. 6 and FIG. 7, a resistance adjustment structure 70 is arranged at the base 50, and the resistance adjustment structure 70 is configured to adjust resistance of the installation frame 10 to rotate relative to the base 50.

The resistance adjustment structure 70 is arranged at the base 50, and the resistance of the installation frame 10 to rotate relative to the base 50 is adjusted by the resistance adjustment structure 70, thereby the difficulty level of the installation frame 10 to rotate relative to the base 50 is adjusted. The rotation of the installation frame 10 relative to the base 50 is more stable and reliable.

In an implementation of the embodiments of the present disclosure, as shown in FIGS. 1 to 3, the first driving member 60 is a folding motor.

According to the layout of motors, the motors can be divided into linear type, folding type, and vertical type. In a linear type motor, a main-body structure and an output shaft are located on the same axis. A folding type motor (also known as reversing motor) or a vertical type motor includes a main-body structure and a drive structure, and an output shaft is arranged at the drive structure. In the folding motor, the main-body structure is parallel to the output shaft, and in the vertical motor, the main-body structure is perpendicular to the output shaft. The first driving member 60 can adopt the folding motor, which occupies less space and is more conducive to structural layout.

In an implementation of the embodiments of the present disclosure, as shown in FIGS. 1 to 3, the driving assembly 40 includes:
a second driving member 41, arranged at the finger portion 30; and
a connector 42, connected to the finger sleeve 20;

The second driving member 41 drives the connector 42 to move relative to the finger portion 30.

The connector 42 is arranged at the finger sleeve 20, and the second driving member 41 is arranged at the finger portion 30. The second driving member 41 is configured to drive the connector 42 to move relative to the finger portion 30, thereby driving the finger sleeve 20 to move relative to the finger portion 30, so that the finger portion 30 slides inside the finger sleeve 20.

The second driving member 41 can be a telescopic driving member, such as a telescopic electric cylinder, etc. An output shaft of the telescopic driving member can be telescopic, and the output shaft of the telescopic driving member is connected to the connector 42 to change a spacing between the connector 42 and the finger portion 30, so as to realize the sliding of the finger portion 30 inside the finger sleeve 20.

In an implementation of the embodiments of the present disclosure, as shown in FIGS. 2, 3, and 6, the output shaft of the second driving member 41 is arranged with a threaded rod 411, the connector 42 is arranged with a screw hole 421, and the screw hole 421 is threadedly connected to the threaded rod 411.

The second driving member 41 drives the threaded rod 411 to rotate. Since the connector 42 is fixed relative to the finger sleeve 20, when the threaded rod 411 rotates, the position of the connector 42 on the threaded rod 411 moves, thereby changing the distance between the second driving member 41 and the connector 42, so that the finger portion 30 slides relative to the finger sleeve 20. The threaded rod 411 and the connector 42 convert the rotation of the output shaft of the second driving member 41 into the relative movement of the connector 42 and the second driving member 41.

In an implementation of the embodiments of the present disclosure, as shown in FIGS. 1 to 3, the finger further includes:
an extended finger 80, rotatably connected to the finger sleeve 20 and the finger portion 30 respectively.

The extended finger 80 is a knuckle extended from the knuckle formed by the finger sleeve 20 and the finger portion 30. The extended finger 80 is rotatably connected to the finger sleeve 20 and the finger portion 30 respectively. When the finger sleeve 20 and the finger portion 30 slide relative to each other, the extended finger 80 rotates relative to the finger sleeve 20 (or the finger portion 30). The driving assembly 40 drives the finger sleeve 20 (or the finger portion 30) to rotate relative to the installation frame 10, and drives the extended finger 80 to rotate relative to the finger sleeve 20 (or the finger portion 30), so that the finger is in a flexed state.

Based on the finger described in any one of the above embodiments, the present disclosure further provides an embodiment of a method for controlling the finger.

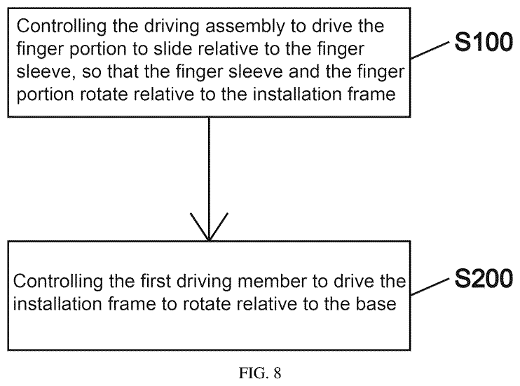

As shown in FIG. 8, the method for controlling the finger of the present disclosure includes:
Step S100: controlling the driving assembly to drive the finger portion to slide relative to the finger sleeve, so that the finger sleeve and the finger portion rotate relative to the installation frame.

By controlling the driving assembly to achieve the sliding of the finger portion relative to the finger sleeve, the finger sleeve and the finger portion both rotate relative to the installation frame, thereby achieving the rotation of the finger and the finger being in the flexed state or an extended state. When the extended finger is set, the finger is flexed in a greater degree.

Step S100 includes following steps:
Step S110: receiving a flexion instruction, and controlling the second driving member to rotate in a forward direction to make the connector close to the second driving member; and
Step S120: receiving an extension instruction, and controlling the second driving member to rotate in a reserve direction to make the connector away from the second driving member.

When the finger needs to be flexed, the flexion instruction is issued. According to the flexion instruction, the second driving member is controlled to rotate in the forward direction, so that the connector and the second driving member are close to each other, the finger sleeve and the finger portion both rotate in the forward direction relative to the installation frame, and the finger is flexed. When the finger needs to be extended, the extension instruction is issued. According to the extension instruction, the second driving member is controlled to rotate in the reverse direction, so that the connector and the second driving member are away from each other, the finger sleeve and the finger portion both rotate in the reverse direction relative to the installation frame, and the finger is extended.

The method for controlling the finger further includes:
Step S200: controlling the first driving member to drive the installation frame to rotate relative to the base.

The orientation of the finger is changed by controlling the first driving member to drive the installation frame to rotate relative to the base. Step S100 and step S200 can be performed separately or simultaneously. With the cooperation of the two steps, the finger can form a variety of different postures.

Based on the finger described in any one of the above embodiments, the present disclosure further provides an embodiment of a robot hand.

The robot hand of the present disclosure includes the finger as described in any one of the above embodiments.

Based on the finger or robot hand described in any one of the above embodiments, the present disclosure further provides an embodiment of a robot.

The robot of the present disclosure includes the finger as described in any one of the above embodiments, or the robot hand as described in any one of the above embodiments.

It should be understood that the application of the present disclosure is not limited to the above examples. For ordinary skilled in the art, improvements or changes can be made based on the above description. All these improvements and changes should fall within the protection scope of the claims attached to the present disclosure.

What is claimed is:

1. A finger comprising:
an installation frame;
a finger sleeve rotatably arranged at the installation frame;
a finger portion rotatably arranged at the installation frame, located inside the finger sleeve, and configured for sliding inside the finger sleeve, wherein a rotational connection position between the finger sleeve and the installation frame is different from a rotational connection position between the finger portion and the installation frame; and
a driving assembly configured to drive the finger portion to slide relative to the finger sleeve, so that the finger sleeve and the finger portion rotate relative to the installation frame;
wherein the driving assembly comprises a second driving member and a connector, the second driving member is arranged at the finger portion, the connector is connected to the finger sleeve, and the second driving member drives the connector to move relative to the finger portion.

2. The finger according to claim 1, further comprising:
a base rotatably connected to the installation frame; and
a first driving member arranged at the base;
wherein the first driving member is configured to drive the installation frame to rotate.

3. The finger according to claim 2, wherein a rotation direction of the base relative to the installation frame is perpendicular to a rotation direction of the finger sleeve relative to the installation frame.

4. The finger according to claim 2, wherein a resistance adjustment structure is arranged at the base, and the resistance adjustment structure is configured to adjust resistance of the installation frame to rotate relative to the base.

5. The finger according to claim 2, wherein the first driving member is a folding motor.

6. The finger according to claim 1, wherein an output shaft of the second driving member is arranged with a threaded rod; and
the connector is arranged with a screw hole, and the screw hole is threadedly connected to the threaded rod.

7. The finger according to claim 1, further comprising:
an extended finger rotatably connected to the finger sleeve and the finger portion respectively.

8. A robot hand comprising:
a finger, and the finger comprises:
an installation frame;
a finger sleeve rotatably arranged at the installation frame;
a finger portion rotatably arranged at the installation frame, located inside the finger sleeve, and configured for sliding inside the finger sleeve, wherein a rotational connection position between the finger sleeve and the installation frame is different from a rotational connection position between the finger portion and the installation frame; and
a driving assembly configured to drive the finger portion to slide relative to the finger sleeve, so that the finger sleeve and the finger portion rotate relative to the installation frame;
wherein the driving assembly comprises a second driving member and a connector, the second driving member is arranged at the finger portion, the connector is connected to the finger sleeve, and the second driving member drives the connector to move relative to the finger portion.

9. The robot hand according to claim 8, wherein the finger further comprises:
a base rotatably connected to the installation frame; and
a first driving member arranged at the base;
wherein the first driving member is configured to drive the installation frame to rotate.

10. The robot hand according to claim 9, wherein a rotation direction of the base relative to the installation frame is perpendicular to a rotation direction of the finger sleeve relative to the installation frame.

11. The robot hand according to claim 9, wherein a resistance adjustment structure is arranged at the base, and the resistance adjustment structure is configured to adjust resistance of the installation frame to rotate relative to the base.

12. The robot hand according to claim 9, wherein the first driving member is a folding motor.

13. The robot hand according to claim 8, wherein an output shaft of the second driving member is arranged with a threaded rod; and
the connector is arranged with a screw hole, and the screw hole is threadedly connected to the threaded rod.

14. The robot hand according to claim 8, wherein the finger further comprises:
an extended finger rotatably connected to the finger sleeve and the finger portion respectively.

15. A robot comprising:
a finger, and the finger comprises:
an installation frame;
a finger sleeve rotatably arranged at the installation frame;
a finger portion rotatably arranged at the installation frame, located inside the finger sleeve, and configured for sliding inside the finger sleeve, wherein a rotational connection position between the finger sleeve and the installation frame is different from a rotational connection position between the finger portion and the installation frame; and
a driving assembly configured to drive the finger portion to slide relative to the finger sleeve, so that the finger sleeve and the finger portion rotate relative to the installation frame;
wherein the driving assembly comprises a second driving member and a connector, the second driving member is arranged at the finger portion, the connector is connected to the finger sleeve, and the second driving member drives the connector to move relative to the finger portion.

16. The robot according to claim 15, wherein the finger further comprises:
a base rotatably connected to the installation frame; and
a first driving member arranged at the base;
wherein the first driving member is configured to drive the installation frame to rotate.

17. The robot according to claim 16, wherein a resistance adjustment structure is arranged at the base, and the resistance adjustment structure is configured to adjust resistance of the installation frame to rotate relative to the base.

18. The robot according to claim 16, wherein the first driving member is a folding motor.

19. The robot according to claim 15, wherein an output shaft of the second driving member is arranged with a threaded rod; and
the connector is arranged with a screw hole, and the screw hole is threadedly connected to the threaded rod.

20. The robot according to claim 15, wherein the finger further comprises:
an extended finger rotatably connected to the finger sleeve and the finger portion respectively.
